(19) United States
(12) Patent Application Publication
(10) Pub. No.: US 2019/0385236 A1
(43) Pub. Date: Dec. 19, 2019

(54) Systems And Methods For Tokenizing Private Finance Using A Distributed Ledger

(71) Applicant: Nth Round, Inc., Milford, DE (US)

(72) Inventors: Christopher Frank McConnell, Berwyn, PA (US); Tracy Gelber Auerbach, Haverford, PA (US); Graham Noble McConnell, Philadelphia, PA (US)

(21) Appl. No.: 16/443,220

(22) Filed: Jun. 17, 2019

Related U.S. Application Data
(60) Provisional application No. 62/686,377, filed on Jun. 18, 2018.

(51) Int. Cl. G06Q 40/06; G06Q 20/06

(52) U.S. Cl. CPC G06Q 40/06; G06Q 20/0655

(57) ABSTRACT

A method for tokenizing private finance may comprise receiving an indication of an investor's investment in an enterprise. Based on the investment, tokens representing equity in the enterprise may be issued to the investor. An indication of a transfer of the investor's shares in an enterprise to a voting trust may be received. Based on the transfer of the investor's shares to the voting trust, tokens representing ownership of interest in the voting trust may be issued to the investor. A distributed ledger transaction may be generated indicating a transfer of the tokens to an account of an investor associated with the investor. The transaction may be caused to be added to a distributed ledger.

### CROSS-REFERENCE TO RELATED APPLICATION

This application claims the benefit of priority to U.S. Provisional Application No. 62/686,377 filed Jun. 18, 2018.

### BACKGROUND

Private enterprises rely on investment in order to operate and grow. Private enterprises may issue equity, such as in the form of units or shares or stock, to investors. However, as private equity may not trade on public exchanges, the equity may be less liquid. Obstacles in liquidating private equity include difficulty in valuation of private equity and difficulty in finding a potential buyer.

Another obstacle in liquidating private equity is the need for a manager to oversee the trading of private equity. For example, a manager may enforce transfer restrictions and exercise rights of refusal of trades, on behalf of a private enterprise. As another example, the manager may oversee private equity trading to ensure that trades comply with policies of the private enterprise or public laws. Furthermore, the sale of private equity may require the oversight of a manager, such as to ensure compliance with equity transaction policies. As an example, in contrast to public market trading, private equity transactions may be limited to high net worth investors (e.g., accredited investors or qualified purchasers). The manager, such as a private company chief financial officer (CFO) may oversee trades to verify that potential sellers and/or buyers are high net worth investors. As another example, the manager may ensure that transactions comply with fiduciary duties, such as fairness to shareholders. As another example, the manager may maintain a record of investors that have private equity, such as in a “stock book.” The involvement of the manager may incur additional costs and may delay the transfer of the equity.

Therefore, investors may face obstacles, should they attempt to liquidate their equity in private enterprises. On the other hand, the same obstacles may deter potential investors from acquiring equity in private enterprises, such as from current equity holders or from fledgling enterprises. Without a known date of an initial public offering (IPO) or with doubt surrounding the viability of new technology being developed by a new private enterprise, potential investors may see the private equity as essentially illiquid. Furthermore, the challenges of monetizing private equity may deter potential investors from financing private enterprises.

### SUMMARY

Systems and methods of tokenizing private finance are described. As an alternative to certificates of shares or stock in a private enterprise, tokens may be issued to investors who fund the private enterprise. Investors who own shares in an enterprise may transfer the shares to a voting trust in exchange for tokens representing interest in the voting trust.

Ownership and transfer of tokens may be recorded in transactions stored on a distributed ledger. Immutable and programmed with rules enforcement, the distributed ledger may serve as a trusted token accounting system. For example, a transfer of tokens from an account of one investor to an account of another investor may be indicated in a transaction. The transaction may be verified, such as by determining that the transferor is in possession of a sufficient number of tokens to make the transfer or by determining that the transferee is authorized to be an investor in the private enterprise. Based on verification of the transaction, the transaction may be added to the distributed ledger.

Tokenization of private equity using the distributed ledger with the smart contract may streamline investing and divesting of private equity for authorized parties, thereby facilitating liquidity of private equity. Tokenization of interests in a voting trust may facilitate meeting onerous requirements that may burden private enterprises.

### BRIEF DESCRIPTION OF THE DRAWINGS

The following drawings illustrate generally, by way of example, but not by way of limitation, various examples discussed in the present disclosure. The file of this patent or application contains at least one drawing/photograph executed in color. Copies of this patent or patent application publication with color drawing(s)/photograph(s) will be provided by the Office upon request and payment of the necessary fee. In the drawings:

FIG. 1 shows an example tokenization schematic.

FIG. 2 shows an example method.

FIG. 3 shows an example user interface.

FIG. 4 shows an example user interface.

FIG. 5 shows an example tokenization schematic.

FIG. 6 shows an example tokenization schematic.

FIG. 7 shows an example method.

FIG. 8 shows an example tokenization schematic.

FIG. 9 shows an example computing environment.

### DETAILED DESCRIPTION

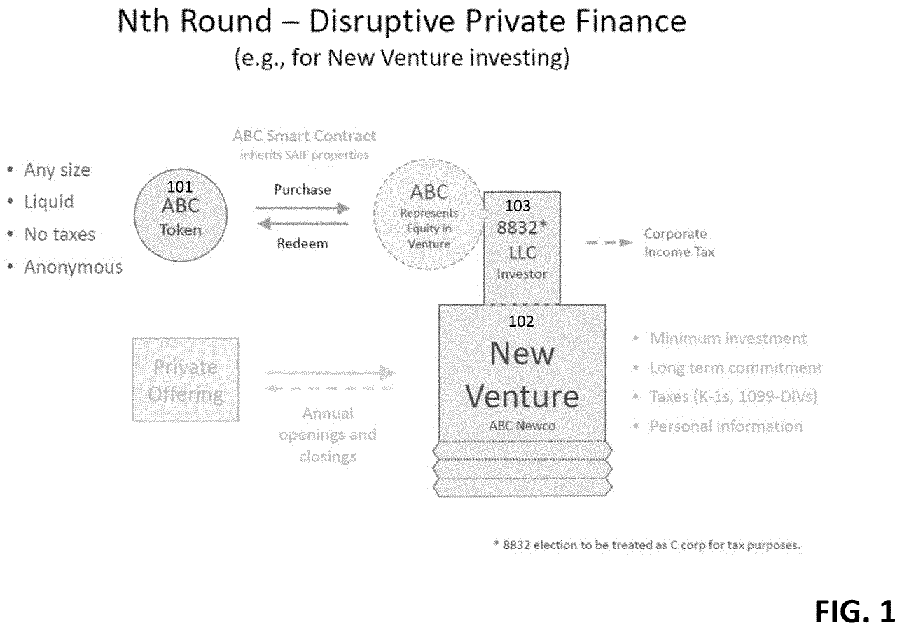

Tokenization of private equity using a distributed ledger may simplify the monetization of equity in a private enterprise, thereby making the equity more liquid and easier to monetize. A private enterprise may comprise a hedge fund, a private equity fund, a partnership, or a pre-initial public offering (IPO) company, as examples. As shown in FIG. 1, as an alternative to certificates of shares or stock in a private enterprise 102, tokens 101 may be issued to investors who fund the private enterprise 102. The tokens 101 may represent ownership of equity in the private enterprise 102. The tokens 101 may represent equity in a legal entity, such as a limited liability corporation (LLC), or in a voting trust 103 or similar vehicle. The legal entity may hold all or some shares or stock in the private enterprise 102. There may exist a fixed number of tokens 101 associated with the private enterprise 102. Alternatively, the number of tokens 101 may be variable.

The tokens 101 may comprise a cryptocurrency. The tokens 101 may comprise mathematical entries (e.g., balances) on a distributed ledger. The distributed ledger may function as an accounting system. Examples of distributed ledgers include the Bitcoin blockchain, the Ethereum blockchain, other advanced programmable distributed ledgers, and/or other tamper-resistant ledgers. The distributed ledger may be private, permissioned, or public. The distributed ledger may comprise a peer-to-peer network. The distributed ledger may comprise a wide-spread network. The distributed ledger may comprise a highly-distributed network. Copies of the distributed ledger may be stored on a plurality of nodes. The nodes may comprise computing devices. The nodes may be located at different geographic locations, such as in different countries. The nodes may be incentivized to verify new transactions and add the transactions to the distributed ledger (e.g., mine) to earn mining fees. The nodes may reach consensus on a correct version of the distributed ledger by each simultaneously checking that local copy of the distributed ledger stored on one of the nodes matches the copies stored on the other nodes. As a result, the distributed ledger may be more trusted than a central authority.

One or more transactions indicating issuance of the tokens 101 may be added to the distributed ledger. The transaction may indicate a transfer of the tokens 101 to the investors, such as a transfer of the tokens 101 from an account associated with the private enterprise to accounts associated with the investors. The accounts may comprise cryptocurrency wallets. The transactions may comprise indications of identifiers of the accounts, such as account addresses or keys. When the tokens 101 are initially distributed, issuing the tokens 101 may comprise causing one or more transactions to be added to the distributor that indicate that balances of the accounts associated with the investors include the tokens 101. The balances may be managed programmatically on the distributed ledger, such as with a smart contract.

The smart contract may comprise a programmed set of rules. The rules may comprise conditions that must be met for a transaction to be added to the distributed ledger. The smart contract may be written in a strongly-typed language, such as the Solidity language.

The smart contract may comprise token rules regarding the generation and/or issuance of the tokens 101. The token rules may comprise time-based rules, such as monthly payments. The token rules may comprise mathematically-calculated rules, such as interest payments. The token rules may be based on external events conveyed to the distributed ledger by an oracle, such as performance payments. The token rules may be immutable. For example, the token rules may be hard-coded. The token rules may be tamper-proof. The token rules may be verified and/or re-verified at regular time intervals or constantly by the nodes.

Tokens 101 may be traded by adding a transaction to the distributed ledger indicating the transfer of tokens 101 between parties. The transactions recorded on the distributed ledger may be linked to deter modification of the transactions. Thus, the transactions may be immutable. The immutability and decentralization of the distributed ledger may foster trust among transacting parties. The immutability may prevent tampering or hacking of the distributed ledger.

The smart contract may comprise transaction rules. The transaction rules may control account balances. For example, based on the transaction rules, a token transfer may decrease a sender's balance and may increase a recipient's balance. The distributed ledger may only accept transactions that satisfy the rules and may deny transactions that do not satisfy the rules. Based on the transaction rules, a transaction indicating a transfer of tokens from an investor may not be added to the distributed ledger if there is not another transaction on the distributed ledger indicating that the tokens 101 are in an account of the investor. Based on the transaction rules, a transaction indicating a transfer of tokens 101 to a recipient may only be added to the distributed ledger if the recipient is a pre-authorized investor. The smart contract's programmable and self-enforcing rules structure may reduce the need for human oversight of private equity trading.

The tokens 101 may comprise specialized tokens, as described in the white paper, A Semi-Fungible Token for Regulatory Compliance (https://saifcoin.com/s/A-Semi-Fungible-Token-for-Regulatory-Compliance-3-14-18.pdf), which is incorporated in its entirety by reference. As described in U.S. Patent Application Ser. No. 62/560,018, which is incorporated in its entirety by reference, the specialized tokens 101 may be only received and only used by accounts that already have at least a small balance of the tokens 101. The accounts may initially obtain the tokens 101 by each being seeded with at least a fraction of a token 101. Alternatively, tokens 101 may be transferred to accounts that are not already in possession of at least a fraction of a token 101. For example, at least a fraction of a token 101 may be transferred to an account, despite the account not pre-possessing at least a fraction of a token 101, based on the account being associated with a pre-qualified investor.

A commission may be charged for token trades. The commission may comprise a transaction fee. For example, the commission may comprise a portion of the tokens being transferred. A node that verifies the transaction and/or adds the transaction to the distributed ledger may be issued the transaction fee. Transaction fees may be flat, such as a fixed fee per transaction or a percentage of the tokens being transferred. Transaction fees may be determined one of the parties to the transaction. The transaction fees may incentivize the nodes to verify and/or add the transactions to the distributed ledger. As an example, the nodes may verify and/or add transactions that have higher transaction fees than other transactions.

The smart contract may be configured to reclaim “misplaced” tokens. Misplaced tokens may comprise tokens 101 that have been lost by the token holders. The smart contract may store or recreate copies of the tokens. The smart contract may re-issue tokens to token holders.

The smart contract may perform fiduciary duties. For example, the smart contract may be configured to reclaim tokens 101 held by a “bad actor.” A bad actor may comprise an investor that is in violation of a securities law. The smart contract may determine that the investor is in violation of the securities law. The smart contract may transfer tokens 101 from the investor's account to another account.

Tokenization of private equity using the distributed ledger with the smart contract may streamline investing and divesting of private equity for authorized parties, thereby facilitating liquidity of private equity. Potential investors may feel more confident about investing, knowing that there exists a means to easily liquidate equity in a private enterprise. Tokenization may enable a private enterprise to take advantage of tax laws that benefit corporations. For example, if enterprise 102 is an LLC and elects on IRS Form 8832 to be taxed as a corporation rather than as a partnership, tokenization may reduce the requirement to complete and submit tax forms. Examples of tax forms include schedule K-1 forms and 1099 forms. Tokenization may facilitate fundraising for a new private enterprise, such as by issuing tokens 101 to early investors. Tokenization may provide a means to reward friends or partners of a private enterprise.

Rather than representing equity in a private enterprise 102, the tokens 101 may represent interest in a voting trust 103. Additionally or alternatively, the tokens 101 may represent interest in an LLC. The voting trust 103 may comprise an entity that holds stock or equity in an enterprise 102 on behalf of one or more parties. For example, shares of stock may be legally transferred from the parties to the voting trust 103. Stock certificates of the parties may be replaced with new ones in the name of the voting trust 103. Yet, “beneficial ownership” may stay with the parties as the original shareholders. For example, the parties may still receive distributions or dividends from the enterprise 102, such as if the enterprise 102 is a large, established company. The voting trust 103 may hold the equity in the enterprise 102 on behalf of the parties for a specified time period. Holders of stock or equity in the enterprise may have the power to make decisions relating to the enterprise 102, such as by voting. The voting trust 103 may make decisions or vote on behalf of the token 101 holders.

A party may trade equity in the enterprise 102 with the voting trust 103 in exchange for tokens 101. A party may invest in the enterprise 102 or in the voting trust 103 in exchange for tokens 101. Whereas Trust Certificates have traditionally been issued to document interest in a voting trust 103, the tokens 101 may be issued instead of the certificates.

The trade may be transacted using a distributed ledger. For example, transaction may be generated comprising an indication of the party, an indication of the transfer of the equity from the party to the voting trust 103, an indication of the voting trust, and/or an indication of the transfer of the tokens 101 to the party. The indication of the transfer of the tokens 101 to the party may comprise an indication of a balance of an account associated with the party, including the tokens. The tokens 101 may be transferred to the party from an account associated with the voting trust 103. The indication of the transfer of the tokens 101 to the party may comprise an indication of a balance of the account associated with the voting trust 103, wherein the balance may reflect that the tokens 101 being transferred to the party have been deducted from the account associated with the voting trust 103. Alternatively, the tokens 101 may be issued to the party from another party associated with the voting trust 103, such as a trustee. The indication of the transfer of the tokens 101 to the party may comprise an indication of a balance of an account associated with the other party, wherein the balance may reflect that the tokens 101 being transferred to the party have been deducted from the account associated with the other party.

The record of the transfer of tokens 101 on the distributed ledger may be an improvement over the traditional practice of issuing certificates to indicate interest in a voting trust. For example, the distributed ledger transactions may maintain the anonymity of the investors. Only indications of the accounts, such as identification numbers of keys, may be recorded in the transactions. Due to the immutable and decentralized nature of distributed ledgers, ownership of interest may be easier to prove or determine using the token system.

The transaction may comprise an indication of a time period for which the voting trust 103 will hold the equity in the enterprise 102. The distributed ledger may comprise a smart contract programmed to add, after the indicated time period, a transaction to the distributed ledger comprising an indication of a transfer of the equity from the voting trust 103 back to the party. The transaction may comprise an indication of a transfer of the tokens 101 from the party to the voting trust 103 or to another party associated with the voting trust 103, such as the trustee.

The transaction may be caused to be stored on the distributed ledger. Causing the transaction to be stored on the distributed ledger may comprise sending an indication of the transaction to a node of a plurality of nodes that each store a copy of the distributed ledger and/or perform operations to add transactions to the distributed ledger.

Token holders may trade the tokens 101 associated with the voting trust 103 on the secondary market, such as with other investors. Trading the tokens 101 among investors may comprise interacting with a user interface. For example, a token 101 holder may indicate, via the user interface, an intention to trade the tokens 101. The token 101 holder may indicate, via the user interface, a number of tokens 101 that the token 101 holder intends to trade. The token 101 holder may indicate, via the user interface, a compensation that the token 101 holder would accept for the tokens. The compensation may comprise traditional currency, cryptocurrency, credit, equity in other enterprises, other tokens (e.g., tokens associated with a different private enterprise), services, goods, and/or other property. A buyer for the tokens 101 may be determined, such as the buyer indicating that they are willing to trade the indicated compensation in exchange for the tokens 101. Alternatively, the token 101 holder may indicate a buyer of the tokens 101.

A transaction may be generated indicating a trade of the tokens 101 between the token 101 holder and the buyer. The transaction may be verified, such as by determining that another transaction stored on the distributed ledger indicates that a balance of an account associated with the token 101 holder includes the tokens that the token 101 holder intends to trade. Based on the verification of the transaction, the transaction may be caused to be added to the distributed ledger.

There may be several advantages to entrusting the voting trust 103 with holding the equity in the enterprise 102 and/or making decisions on behalf of the token 101 holders. For example, voting trusts 103 receive a special exemption from the definition of an investment company in the Investment Company Act of 1940. Specifically, a voting trust with assets of which consist exclusively of securities of a single issuer does not qualify as an investment company. As a result, onerous compliance rules for investment companies do not apply to voting trusts 103, such as rules requiring arduous registration processes, Series 7 exams for principals, and special reporting requirements. Furthermore, current regulations do not restrict the transfer of interest in voting trusts 103. Voting trust agreements often anticipate transfers and provide appropriate mechanisms to handle transfers.

Additionally, the transfer of shares of an enterprise 102 to a voting trust 103 may not be considered asset sales. Therefore, the transfer of shares may not trigger capital gains treatment, such as tax requirements. For example, if the voting trust 103 is set to expire after a specified time period, capital gains treatment may not be triggered, as taxing a transfer of shares in and taxing the transfer of shares out would not be consistent with corporate laws.

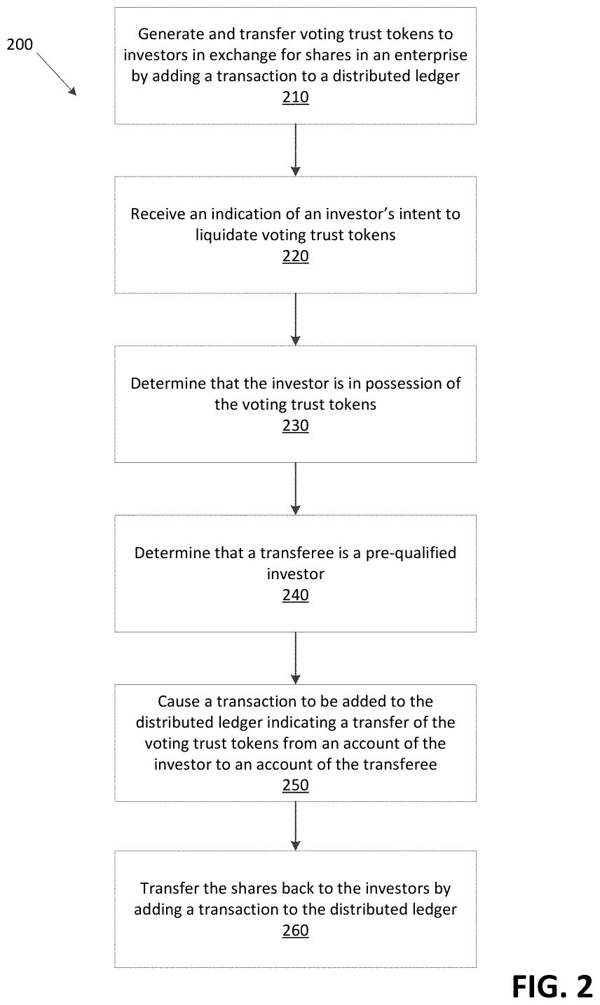

FIG. 2 shows an example method 200 of tokenizing private enterprise investment using a voting trust and a distributed ledger. At step 210, tokens may be generated. The tokens may represent interest in the voting trust (e.g., voting trust 103 in FIG. 1).

Generating the tokens may comprise issuing the tokens to the investors in exchange for shares in an enterprise (e.g., enterprise 102 in FIG. 1). Issuing the tokens to the investors may comprise causing one or more transactions to be added to the distributed ledger. The transaction may indicate a transfer of the tokens to the investors, such as a transfer of the tokens from an account associated with the voting trust to accounts associated with the investors. When the tokens are initially distributed, issuing the tokens may comprise causing one or more transactions to be added to the distributor that indicate that balances of the accounts associated with the investors include the tokens. The balances may be managed programmatically on the distributed ledger. The distributed ledger may deploy a smart contract.

The distributed ledger may be stored on a plurality of nodes. The tokens may be generated and/or issued by one or more of the plurality of nodes. The tokens may be generated and/or issued by a computing device. The computing device may be in communication with the plurality of nodes.

At step 220, an indication may be received that one or more of the investors intend to liquidate their tokens. The indication may be input via a user interface. The indication may be received by a node of the blockchain. The indication may comprise an indication of a number of tokens that the investor wants to liquidate. The indication may comprise an indication of a compensation that the investor wants in exchange for the tokens. The compensation may comprise traditional currency, cryptocurrency, credit, equity in other enterprises, other tokens (e.g., tokens associated with a different private enterprise), services, goods, and/or other property.

The indication of the investor's intent to liquidate tokens may comprise an indication of a transferee of the tokens. Alternatively, a potential transferee of the tokens may be determined. For example, the transferee may be determined based on a received indication that the potential transferee is willing to trade a compensation for a number of tokens that is consistent with the consideration indicated by the transferor. The indication may be input via a user interface. The indication may be received by one of the plurality of nodes. The indication may be received by a computing device in communication with the plurality of nodes.

At step 230, it may be determined that the investor intending to liquidate the tokens is in possession of the tokens. Determining that the investor is in possession of the tokens may comprise determining that the distributed ledger comprises a transaction indicating a previous transfer of the tokens to the investor, such as a transaction added to the distributed ledger in step 210. Determining that the investor is in possession of the tokens may comprise determining that a sufficient number of tokens are in an account of the investor to liquidate the indicated number of tokens, such as based on a distributed ledger transaction indicating a balance of the account. One of the plurality of nodes may determine that the investor is in possession of the tokens. A computing device in communication with the plurality of nodes may determine that the investor is in possession of the tokens.

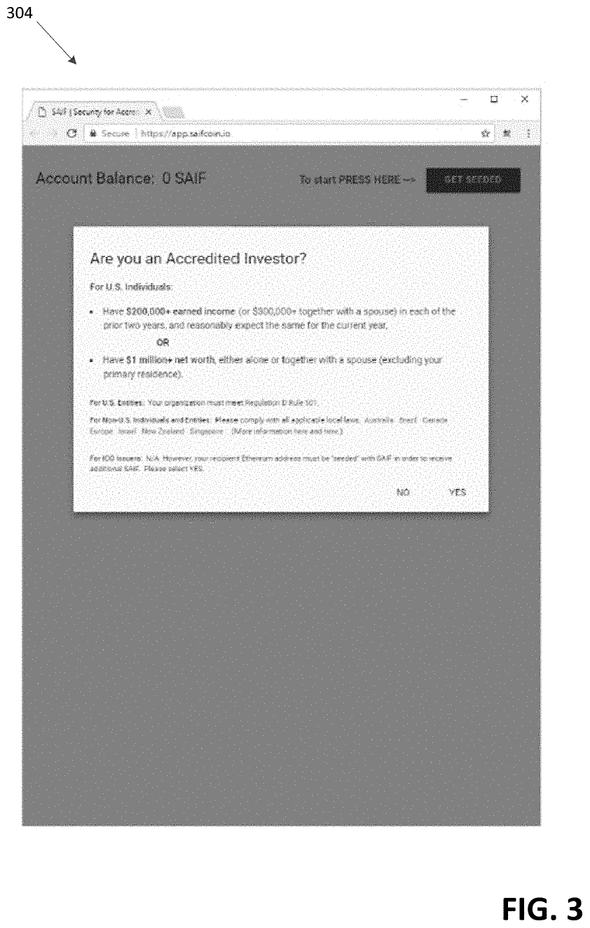

At step 240, it may be determined that a transferee of the tokens comprises a pre-authorized investor. Determining that the transferee comprises a pre-authorized investor may comprise determining that the transferee is a current investor in the private voting trust and/or is a current token holder. Determining that the transferee is pre-authorized may be based on receiving, via a user interface (e.g., user interface 304 in FIG. 3), an input indicating that the transferee is pre-authorized. The input may be in response to a prompt, via the user interface, to certify that the transferee is authorized. One of the plurality of nodes may determine that the transferee comprises a pre-authorized investor. A computing device in communication with the plurality of nodes may determine that the transferee comprises a pre-authorized investor.

At step 250, the tokens may be transferred from the investor to the transferee. Transferring to the transferee may comprise causing a transaction to be added to the distributed ledger. The transaction may indicate a transfer of the tokens to the transferee, such as a transfer of the tokens from an account associated with the investor to an account associated with the transferee. When the tokens are initially distributed, issuing the tokens may comprise causing one or more transactions to be added to the distributor that indicate that balances of the accounts associated with the investors include the tokens.

Each transaction on the distributed ledger may comprise an indication of a transaction previously added to the distributed ledger. The indications may link the transactions. The indications may show a sequence in which the transactions were added to the distributed ledger. The indications may prevent modification of the transactions stored on the distributed ledger. An indication of a previous transaction added to the distributed ledger may be added to the transaction.

One of the plurality of nodes may cause the transaction to be added to the distributed ledger. One of the plurality of nodes may add the transaction to the distributed ledger. Adding the transaction to the distributed ledger may comprise sending an indication of the transaction to one or more of the nodes. The transaction sent may comprise the value linking the transaction to the previous transaction. Adding the transaction to the distributed ledger may comprise sending a copy of the distributed ledger comprising the transaction to the nodes.

At step 260, the shares may be transferred back to the investors. For example, if the voting trust is set to expire after a time period, the shares may be transferred to the investors when the time period lapses. Transferring the shares back to the investors may comprise generating one or more transactions configured for the distributed ledger. The smart contract of the distributed ledger may be programmed to generate the one or more transactions based on the expiration of the time period. The transactions may comprise an indication of one or more of the investors. The transactions may comprise an indication of a change in the balances or transfer of the tokens from the accounts associated with the investors. The transactions may comprise an indication of a transfer of the tokens to the account associated with voting trust. Alternatively, the tokens may be eliminated, such as by deducting the tokens from the accounts of the investors and not adding the tokens to other accounts. The transactions may comprise an indication of the shares. The transactions may comprise an indication of a transfer of the shares from the voting trust to the investors. Alternatively, or additionally, new stock certificates may be generated in the names of the investors.

The transactions may be caused to be added to the distributed ledger. Causing the transactions to be added to the distributed ledger may comprise sending an indication of the transactions to a node of the distributed ledger.

As shown in FIG. 3, a potential buyer may be asked to confirm that they are a pre-qualified investor via a user interface 304. Based on the potential buyer's input via the user interface, the smart contract may determine that the potential buyer comprises a pre-qualified buyer. In this way, the distributed ledger may function as a “walled garden” available only to pre-qualified investors, such as parties determined to be high net worth investors. If a token holder attempts to transfer a token to an account associated with an investor who is not pre-qualified, the transaction may not be accepted on the distributed ledger. A notification may be sent to the token holder indicating that the attempted transaction was disallowed.

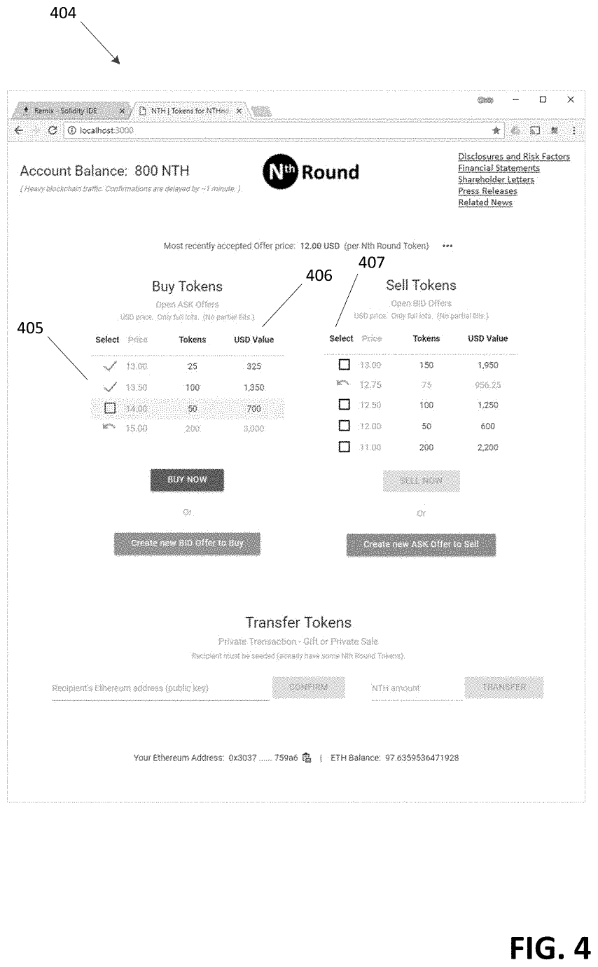

FIG. 4 shows another user interface 404 of an example platform. The platform may determine current exchange rates of the tokens to other currencies and/or cryptocurrencies. As shown in FIG. 4, a potential buyer may indicate how many tokens she wants to buy. The potential buyer may indicate the number of tokens by selecting an icon 405. The user interface 404 may indicate a number of units of another currency or cryptocurrency that has an equivalent value to the tokens according to the current exchange rate. A current token holder may indicate a number of tokens that she wishes to sell. The potential buyer may indicate the number of tokens by selecting an icon 407. The user interface may indicate a number of units of another currency or cryptocurrency 406 that has an equivalent value to the tokens according to the current exchange rate.

The smart contract and/or the platform may determine a buyer or seller who is willing to sell or buy the tokens for the indicated amounts. A transaction may be generated that indicates a transfer of the tokens from an account of the seller to an account of the buyer. The transaction may indicate a transfer of the compensation, such as Ether, from an account of the buyer to an account of the seller. The smart contract may verify the transaction. Verifying the transaction may comprise determining that the buyer and/or the seller are pre-qualified investors. Verifying the transaction may comprise determining that the transaction indicates an exchange of tokens and compensation that was agreed upon. Based on verification of the transaction, the smart contract may cause the transaction to be added to the distributed ledger.

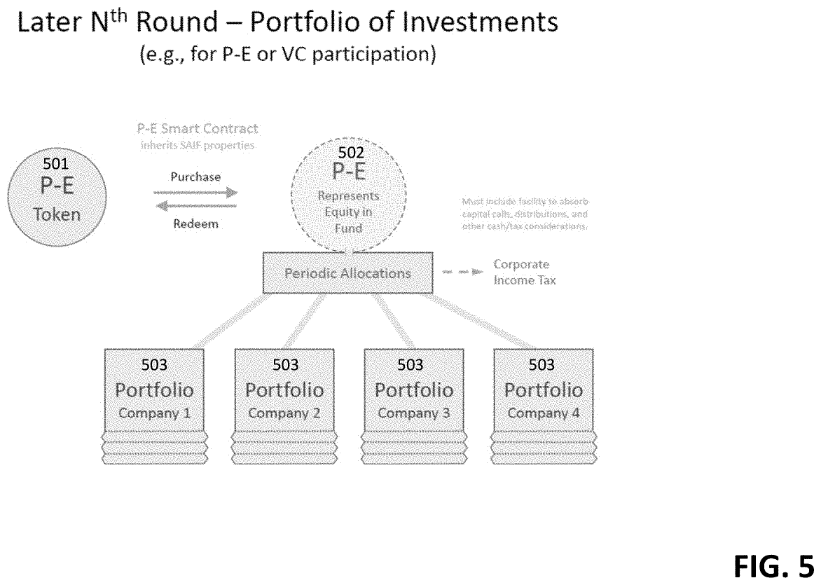

As shown in FIG. 5, tokens 501 may be generated and issued that represent equity in a fund 502. The fund 502 may comprise a hedge fund, a private equity fund, a partnership, or an enterprise capital fund, as examples. Investors may finance the fund 502. In exchange for financing, the investors may receive tokens 501. The tokens 501 may be transferred to the investors by causing one or more transactions to be added to a distributed ledger. The transactions may indicate a transfer of the tokens 501 to accounts associated with the investors.

The fund 502 may invest the funds from the financing in one or more portfolios 503. The portfolios 503 may comprise equity in one or more companies. As the tokens may represent equity in the fund 502, the investors may effectually have equity in the companies.

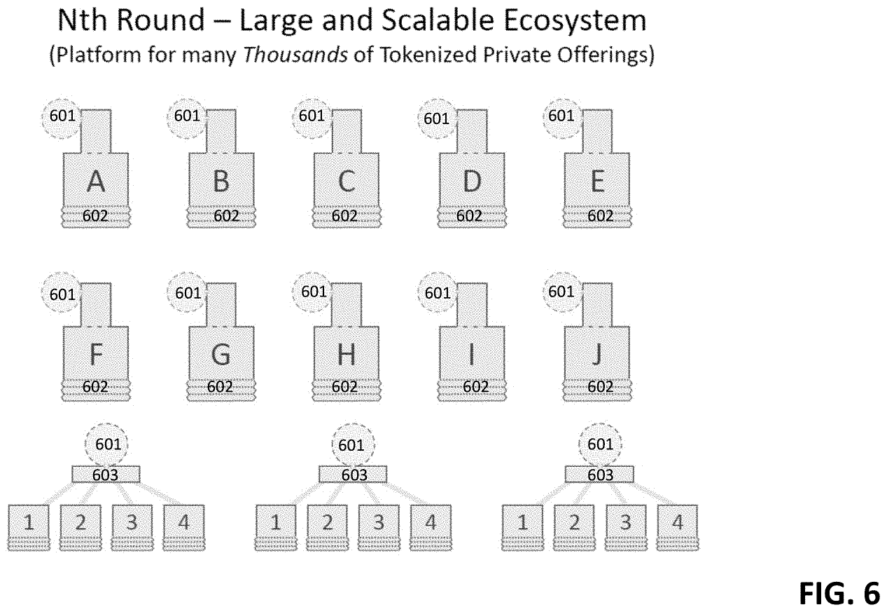

As shown in FIG. 6, the tokenization of equity in companies and funds may be scalable. Tokens 601 may be generated for a plurality of funds 603. Each of the funds 603 may invest funding from investors in one or more companies. The tokens 601 may be traded using the same distributed ledger. Alternatively, each of the companies 602 or funds 603 may have a distributed ledger on which tokens 601 associated with the each of the companies 602 or funds 603 may be traded.

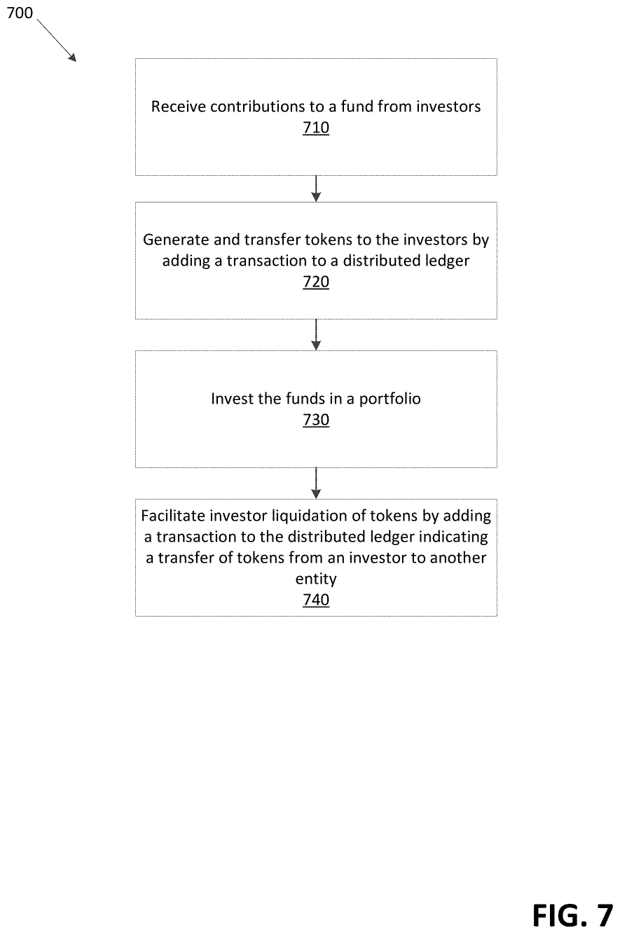

FIG. 7 shows an example method 700 by which equity in a fund may be tokenized. At step 710, investors may contribute to a fund. The fund may comprise a private equity fund, a partnership, a hedge fund, a private equity fund, or an enterprise capital fund, as examples.

At step 720, tokens may be generated that represent equity in a fund (e.g., fund 502 in FIG. 5, fund 603 in FIG. 6). Generating the tokens may comprise causing one or more transactions to be added to a distributed ledger. The distributed ledger may be associated with the fund. The distributed ledger may comprise a blockchain.

The tokens may be transferred to the investors. Issuing the tokens may comprise indicating, in the transactions added to the distributed ledger, that the tokens are transferred to the investors. The transactions may indicate that the tokens are transferred from an account associated with the fund to accounts associated with the investors. The accounts may be associated with the distributed ledger. The accounts may comprise cryptocurrency wallets. The transactions may comprise an indication of an identifier of the accounts, such as account addresses or keys. The indication of the transfer of the tokens may comprise an indication of an old balance of the account of the fund, an indication of a new balance of the account of the fund, an indication of an old balance of the accounts of the investors, and/or an indication of a new balance of the account of the investors.

At step 730, the fund may invest the funds from the investors in one or more portfolios. Each of the portfolios may comprise one or more companies. The fund may own shares of stock or equity in the one or more companies.

At step 740, one or more of the investors may liquidate their tokens. Liquidating the tokens may comprise monetizing the tokens. Liquidating the tokens may comprise selling or trading the tokens to another investor. Liquidating the tokens may comprise trading the tokens for shares of stock or equity in the companies in the portfolios of the fund. The investors may transfer the tokens to the fund in exchange for the stock or equity.

An investor may liquidate tokens by indicating, via a user interface, an intention to transfer the tokens, such as via the user interface shown in FIG. 4. The investor may indicate numbers of tokens that she intends to liquidate. The investor may indicate compensation that she would accept in exchange for the tokens. A program of the user interface may be configured to identify demand for the tokens, such as a buyer who is willing to exchange the indicated compensations for all or some of the tokens.

A smart contract programmed on a distributed ledger may determine that the buyer is pre-qualified. Determining that buyer is pre-qualified may comprise determining that the buyer is a high net income investor. Determining that the buyer is pre-qualified may be based on an indication that the buyer is pre-qualified input via a user interface, such as the user interface shown in FIG. 3.

Based on the determining that the buyer is pre-qualified, a transaction may be caused to be added to the distributed ledger. The transaction may indicate a transfer of the tokens from the investor to the buyer. The transaction may indicate a transfer of the tokens from an account of the investor to an account of the buyer. The indication of the transfer of the tokens may comprise an indication of an old balance of the account of the investor, an indication of a new balance of the account of the investor, an indication of an old balance of the account of the buyer, and/or an indication of a new balance of the account of the buyer. The accounts may be associated with the distributed ledger. The accounts may comprise cryptocurrency wallets. The transactions may comprise an indication of an identifier of the accounts, such as account addresses or keys.

If the investor is trading the tokens for shares of stock held by the fund, a transaction may be caused to be added to the distributed ledger that may indicate a transfer of the tokens from an account of the investor to an account of the fund. The indication of the transfer of the tokens may comprise an indication of an old balance of the account of the investor, an indication of a new balance of the account of the investor, an indication of an old balance of the account of the fund, and/or an indication of a new balance of the account of the fund. The transaction may indicate a number of shares of stock or other equity in the companies that is transferred to the investor.

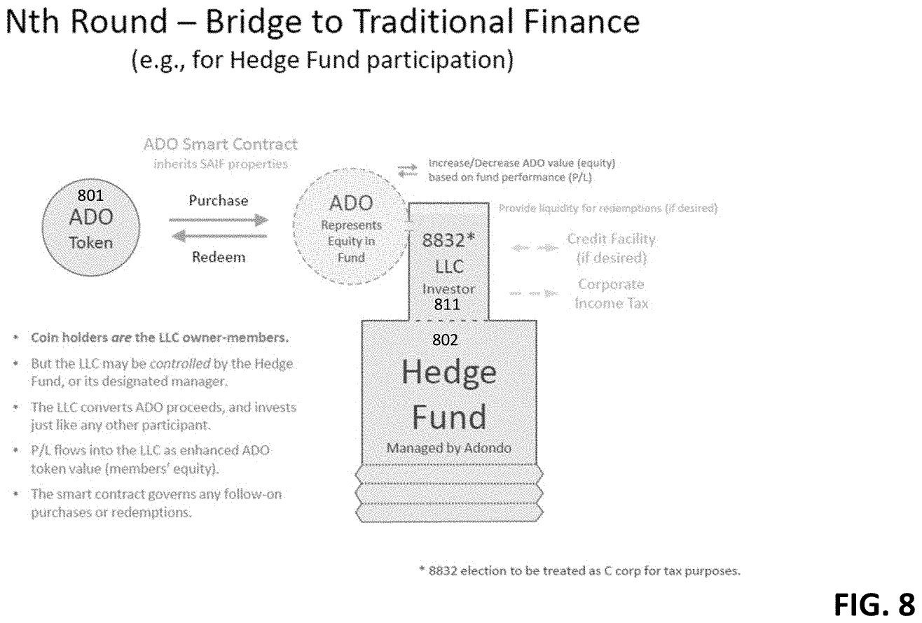

As shown in FIG. 8, tokenization of private equity may comprise a bridge to traditional finance. A legal entity 811, such as an LLC may be formed. The legal entity 811 may be treated as a C corporation, such as for tax purposes. Tokens 801 associated with a private enterprise 802 may be issued to investors that contribute to the private enterprise 802. The private enterprise 802 may comprise a fund, such as a hedge fund. The private enterprise 802 may comprise a company. If the private enterprise 802 comprises a company, stock in the private enterprise 802 may be issued to the legal entity 811. The tokens 801 may represent equity in the private enterprise 802 or the tokens 801 may represent equity in the legal entity 811. According to this method, investors may trade tokens 801, without invoking the legal regime pertaining to the trade of stock or other securities. The investors may transfer tokens 801 to the legal entity 811 in exchange for shares of stock from the legal entity 811, such as stock in the private enterprise 802 or stock in companies and/or portfolios owned by the private enterprise 802 (e.g., if the private enterprise comprises a fund).

Holders of the tokens 801 may be owners and/or members of the legal entity 811. However, the legal entity 811 may be controlled by the private enterprise 802 or its designated manager. The legal entity 811 may invest the funds, such as in other companies. The tokens 801 may be traded on a distributed ledger associated with the private enterprise 802 and/or legal entity 811. The distributed ledger may comprise a smart contract. The smart contract may govern trades of the tokens 801. The number of tokens 801 that exist and/or are held by investors may be increased or decreased. For example, the number of tokens 801 may be changed based on performance of the private enterprise 802.

A token holder may liquidate her tokens 801. The token holder may liquidate her tokens 801 by transferring the tokens 801 to another investor. In exchange, the token holder may receive compensation. The token holder may liquidate her tokens 801 by transferring the tokens 801 to another investor, such as in exchange for shares of stock or equity in the other companies.

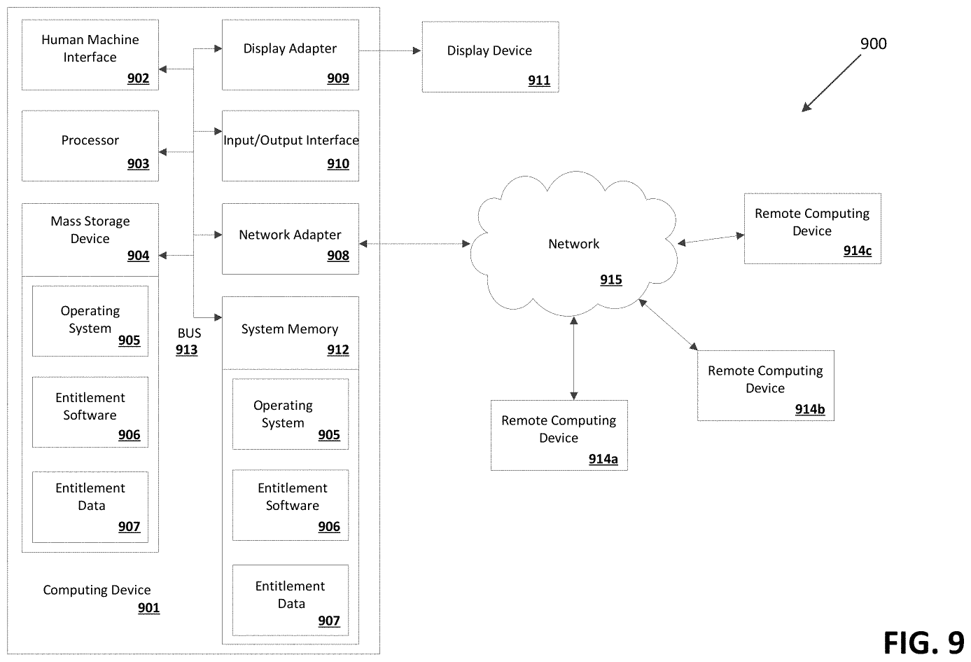

FIG. 9 shows a block diagram illustrating an exemplary operating environment 900 for performing the disclosed methods of transacting in a specialized cryptocurrency. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules comprise computer code, routines, programs, objects, components, data structures, etc. that performs particular tasks or implement particular abstract data types. The disclosed methods may also be practiced in grid- based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods disclosed herein may be implemented via a general-purpose computing device in the form of a computing device 901. The components of the computing device 901 may comprise, but are not limited to, one or more processors or processing units 903, a system memory 912, and a system bus 913 that couples various system components including the processor to 903 the system memory 912. In the case of multiple processing units 903, the system may utilize parallel computing.

The system bus 913 represents one or more of several possible types of bus structures, including a memory bus or memory controller, a peripheral bus, an accelerated graphics port, and a processor or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 913, and all buses specified in this description may also be implemented over a wired or wireless network connection and each of the subsystems, including the processor 903, a mass storage device 904, an operating system 905, entitlement software 906, entitlement data 907, a network adapter 908, system memory 912, an Input/Output Interface 910, a display adapter 909, a display device 911, and a human machine interface 902, may be contained within one or more remote computing devices 914a,b,c at physically separate locations, connected through buses of this form, in effect implementing a fully distributed system.

The computing device 901 typically comprises a variety of computer readable media. Exemplary readable media may be any available media that is accessible by the computing device 901 and comprises, for example and not meant to be limiting, both volatile and non-volatile media, removable and non-removable media. The system memory 912 comprises computer readable media in the form of volatile memory, such as random access memory (RAM), and/or non-volatile memory, such as read only memory (ROM). The system memory 912 typically contains data such as entitlement data 907 and/or program modules such as operating system 905 and entitlement software 906 that are immediately accessible to and/or are presently operated on by the processing unit 903.

In another aspect, the computing device 901 may also comprise other removable/non-removable, volatile/non-volatile computer storage media. By way of example, FIG. 9 illustrates a mass storage device 904 which may provide non-volatile storage of computer code, computer readable instructions, data structures, program modules, and other data for the computing device 901. For example and not meant to be limiting, a mass storage device 904 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 904, including by way of example, an operating system 905 and entitlement software 906. Each of the operating system 905 and entitlement software 906 (or some combination thereof) may comprise elements of the programming and the entitlement software 906. Entitlement data 907 may also be stored on the mass storage device 904. Entitlement data 907 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

In another aspect, the user may enter commands and information into the computing device 901 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices may be connected to the processing unit 903 via a human machine interface 902 that is coupled to the system bus 913, but may be connected by other interface and bus structures, such as a parallel port, game port, an IEEE 994 Port (also known as a Firewire port), a serial port, or a universal serial bus (USB).

In yet another aspect, a display device 911 may also be connected to the system bus 913 via an interface, such as a display adapter 909. It is contemplated that the computing device 201 may have more than one display adapter 909 and the computer 901 may have more than one display device 911. For example, a display device may be a monitor, an LCD (Liquid Crystal Display), or a projector. In addition to the display device 911, other output peripheral devices may comprise components such as speakers (not shown) and a printer (not shown) which may be connected to the computing device 901 via Input/Output Interface 910. Any step and/or result of the methods may be output in any form to an output device. Such output may be any form of visual representation, including, but not limited to, textual, graphical, animation, audio, tactile, and the like. The display 911 and computing device 901 may be part of one device, or separate devices.

The computing device 901 may operate in a networked environment using logical connections to one or more remote computing devices 914a,b,c. By way of example, a remote computing device may be a personal computer, portable computer, a smart phone, a server, a router, a network computer, a peer device or other common network node, and so on. Logical connections between the computing device 901 and a remote computing device 914a,b,c may be made via a network 915, such as a local area network (LAN) and a general wide area network (WAN). Such network connections may be through a network adapter 908. A network adapter 908 may be implemented in both wired and wireless environments. Such networking environments are conventional and commonplace in dwellings, offices, enterprise-wide computer networks, intranets, and the Internet.

For purposes of illustration, application programs and other executable program components such as the operating system 905 are illustrated herein as discrete blocks, although it is recognized that such programs and components reside at various times in different storage components of the computing device 901, and are executed by the data processor(s) of the computer. An implementation of entitlement software 906 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The present disclosure comprises at least the following non-limiting examples and implementations. Such description is not intended to limit the scope of the disclosure, but instead to provide an illustrative embodiment in accordance with the present disclosure.

What is claimed:

1. A method comprising:
receiving an indication of a transfer of shares in an enterprise from investors to a voting trust; and
causing, based on the transfer of shares, one or more initial transactions to be added to a distributed ledger, wherein the one or more initial transactions indicate a transfer of tokens to the investors, wherein the tokens represent interest in the voting trust.

2. The method of claim 1, wherein the method further comprises:
determining an expiration of a time period associated with the voting trust; and
causing, based on the expiration of the time period, one or more subsequent transactions to be added to the distributed ledger, wherein the one or more initial transactions indicate a transfer of the shares in the enterprise from the voting trust and to the investors.

3. The method of claim 1, wherein the voting trust has the authority to make decisions associated with the enterprise on behalf of the investors.

4. The method of claim 1, wherein the method further comprises:
receiving an indication of a transfer of at least a fraction of a token from one of the investors to a transferee; and
causing, based on a determination that at least one transaction on the distributed ledger indicates that the one of the investors is in possession of the at least the fraction of the token, a new transaction to be added to the distributed ledger, wherein the new transaction indicates a transfer of the at least the fraction of the token from an account of the one of the investors to an account of the transferee.

5. The method of claim 4, wherein the causing the new transaction to be added to the distributed ledger is further based on a determination that the transferee comprises a pre-qualified investor.

6. A method comprising:
receiving an indication of investment in an enterprise;
determining, based on an amount of the investment, a portion of a plurality of tokens associated with the enterprise;
generating a transaction for a distributed ledger, wherein the transaction comprises an indication of the portion of the plurality of tokens and an indication of a recipient of the portion of the plurality of tokens, wherein the recipient comprises an investor associated with the investment; and
causing the transaction to be added to the distributed ledger.

7. The method of claim 6, wherein the plurality of tokens represent equity in the enterprise.

8. The method of claim 6, wherein the enterprise comprises a limited liability company (LLC).

9. The method of claim 8, wherein the LLC makes an 8832 election.

10. The method of claim 6, wherein the enterprise comprises at least one of a hedge fund, a private equity fund, a partnership, or a private company.

11. The method of claim 6, wherein the distributed ledger comprises a smart contract; and
wherein the transaction is added to the distributed ledger based on satisfaction of one or more rules of the smart contract.

12. The method of claim 10, wherein the one or more rules require that the recipient be a pre-authorized investor.

13. The method of claim 10, wherein the one or more rules require that the recipient possess at least a fraction of a token.

14. The method of claim 10, wherein the smart contract causes new tokens to be generated at time intervals.

15. The method of claim 10, wherein the smart contract causes new transactions indicating a transfer of tokens to the investor to be added, at time intervals, to the distributed ledger.

16. A method comprising:
determining an amount of investment of a plurality of investors in an enterprise;
determining, based on the amount, a number of tokens associated with the enterprise to issue to each of the plurality of investors;
generating, for the each of the plurality of investors, a transaction for a distributed ledger, wherein the transaction comprises an indication of the number of tokens and an indication to transfer the number of tokens associated with the enterprise to an account associated with the each of the plurality of investors; and
causing the transaction to be added to the distributed ledger.

17. The method of claim 16, wherein a fixed number of tokens exists.

18. The method of claim 16, wherein the transaction further comprises an indication to transfer the number of tokens from an account associated with the enterprise.

19. The method of claim 16, wherein the indication to transfer the number of tokens associated with the enterprise to the account associated with the each of the plurality of investors comprises an indication of a balance of the account, wherein the balance includes the number of tokens.

20. The method of claim 16, wherein the distributed ledger is stored across a plurality of nodes; and
wherein the causing the transaction to be added to the distributed ledger comprises sending, to at least one of the plurality of nodes, an indication of the transaction.
